(19) United States
(12) Patent Application Publication
(10) Pub. No.: US 2010/0289299 A1
(43) Pub. Date: Nov. 18, 2010

(54) SLIDING DOOR MECHANISMS AND VEHICLES INCLUDING SAME

(76) Inventor: Kenichi Kitayama, Dublin, OH (US)

Correspondence Address: ULMER & BERNE, LLP;ATTN: DIANE BELL, 600 VINE STREET, SUITE 2800, CINCINNATI, OH, 45202, US

(21) Appl. No.: 12/465,353

(22) Filed: May 13, 2009

(51) Int. Cl. E05D 15/10; B60J 5/06; E05D 15/06

(52) U.S. Cl. 296/202; 49/213; 49/212

(57) ABSTRACT

A sliding mechanism is configured for attaching a sliding door to a body structure of a vehicle such that the sliding door is movable with respect to the body structure between closed and opened positions. The sliding mechanism includes a guide track and a roller member. The guide track is configured for attachment to the body structure of the vehicle. The roller member is configured for attachment to the sliding door. The roller member is movably engaged with the guide track. Vehicles are also provided.

### TECHNICAL FIELD

The present invention relates to sliding mechanisms to facilitate attachment of a sliding door to a body structure of a vehicle.

### BACKGROUND

Some conventional minivans are provided with a sliding rear side door which facilitates selective ingress and egress of cargo and/or passengers through an access opening and with respect to a passenger compartment of the minivan. For example, one conventional minivan includes a sliding mechanism which facilitates attachment of a sliding door to a body structure of the minivan such that the sliding door is movable with respect to the body structure between closed and opened positions. With reference to FIGS. 11-14, the sliding mechanism includes multiple guide tracks (e.g., upper and lower guide tracks 140 and 150) and multiple roller members (e.g., upper and lower roller members 142 and 152). The guide tracks are attached to the body structure of the minivan and the roller members are attached to a sliding door 124.

In particular, with reference to FIGS. 12 and 14, it can be seen that, as a rotatable disk 144 of the upper roller member 142 approaches an end 149 of the upper guide track 140 for the sliding door 124 to assume a closed position, the upper roller member 142 follows a curvilinear pathway having components in both the X-axis and the Y-axis. The pathway is defined by an engagement surface 141 which is contacted by a circumferential surface 146 of the disk 144. FIG. 14 illustrates alternative positions 144a and 144b of the disk 144 and corresponding alternative positions 124a and 124b of the sliding door 124 with respect to a driver door 122 of the minivan as the sliding door 124 moves slightly when in the closed position. With reference to FIG. 13, the disks (e.g., 154) of the lower roller member 152 behave similarly in such circumstances.

When the sliding door 124 is in a closed position and experiences slight variation in position, the sliding door 124 does not move along a straight line, but rather moves along a curvilinear pathway (i.e., along both an X-axis and a Y-axis), and such movement of the sliding door 124 can render sealing of the sliding door 124 ineffective. In addition, large amounts of force might be required of a person or power actuator to move the sliding door 124 to or from its closed position. Such a conventional configuration also can result in compromised fit and finish of the sliding door 124 with respect to adjacent body panels (e.g., the driver door 122), which in turn can result in excessive manufacturing time and cost for a vehicle. This conventional configuration can also result in squeaking of a seal member when the sliding door 124 experiences slight movements when in the closed position.

### SUMMARY

In accordance with another embodiment, a vehicle comprises a body structure, a guide track, and a sliding door. The guide track is attached to the body structure and comprises an engagement surface. The engagement surface has a first linear section, a second linear section, and a curvilinear section separating the first and second linear sections. The first and second linear sections are parallel with one another. The sliding door comprises a roller member. The roller member comprises a disk having a circumferential surface. The circumferential surface contacts the engagement surface as the sliding door moves with respect to the body structure between closed and opened positions. The circumferential surface of the disk contacts the first linear section of the engagement surface when the sliding door is in the opened position. The circumferential surface of the disk contacts the second linear section of the engagement surface when the sliding door is in the closed position.

In accordance with another embodiment, a vehicle comprises a body structure, a guide track attached to the body structure, and a sliding door. The sliding door comprises a roller member and is movable with respect to the body structure between closed and opened positions. The roller member is movably engaged with the guide track and is constrained by the guide track to move along a pathway as the sliding door moves between the closed and opened positions. The pathway comprises a first linear portion, a second linear portion, and a curvilinear portion separating the first and second linear portions. The roller member is positioned at the first linear portion of the pathway when the sliding door is in the opened position. The roller member is positioned at the second linear portion of the pathway when the sliding door is in the closed position. The first and second linear portions are parallel with one another.

In accordance with yet another embodiment, a vehicle comprises a body structure, at least one front wheel, at least one rear wheel, a guide track, and a sliding door. The rear wheel(s) is/are rotatable with respect to the body structure about a rotational axis. The guide track is attached to the body structure. The sliding door comprises a roller member and is movable with respect to the body structure between closed and opened positions. The roller member is movably engaged with the guide track and is constrained by the guide track to move along a pathway as the sliding door moves between the closed and opened positions. The pathway comprises a first linear portion, a second linear portion, and a curvilinear portion separating the first and second linear portions. The roller member is positioned at the first linear portion of the pathway when the sliding door is in the opened position. The roller member is positioned at the second linear portion of the pathway when the sliding door is in the closed position. The second linear portion lies within a plane which perpendicularly intersects the rotational axis of the rear wheel(s).

In accordance with still another embodiment, a sliding mechanism is configured for attaching a sliding door to a body structure of a vehicle such that the sliding door is movable with respect to the body structure between closed and opened positions. The sliding mechanism comprises a guide track and a roller member. The guide track is configured for attachment to a body structure of a vehicle and extends between first and second ends. The roller member is configured for attachment to a sliding door. The roller member is movably engaged with the guide track and is constrained by the guide track to move along a pathway. The pathway comprises a first linear portion, a second linear portion, and a curvilinear portion separating the first and second linear portions. The first linear portion of the pathway is at the first end of the guide track. The first and second linear portions are parallel with one another.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a left side elevational view depicting a minivan in accordance with one embodiment, wherein a left sliding rear side door is in a closed position;

FIG. 2 is a left side elevational view depicting the minivan of FIG. 1, wherein the left sliding rear side door is in a opened position;

FIG. 3 is an enlarged left side elevational view depicting the left sliding rear side door and associated guide tracks removed from the minivan of FIG. 1, wherein certain hidden portions are shown in dashed lines;

FIG. 4 is an enlarged perspective view depicting the left sliding rear side door and associated guide tracks removed from the minivan of FIG. 1, wherein portions of the sliding door are shown in dashed lines for clarity of illustration;

FIG. 5 is an enlarged perspective view depicting the left sliding rear side door and associated guide tracks removed from the minivan of FIG. 2, wherein portions of the sliding door are shown in dashed lines for clarity of illustration;

FIG. 6 is an enlarged top plan view depicting the left sliding rear side door and associated upper guide track of FIGS. 3-4, wherein certain hidden surfaces of the upper guide track are shown in dashed lines;

FIG. 7 is an enlarged top cross-sectional view depicting the left sliding rear side door and associated lower guide track of FIGS. 3-4, wherein certain hidden surfaces of the lower guide track are shown in dashed lines;

FIG. 8 is an enlarged top plan view depicting portions of a driver door, an upper guide track, and the left sliding rear side door of the minivan of FIG. 1;

FIG. 9 is an enlarged top cross-sectional view depicting portions of a driver door, a body structure, a seal member, and the left sliding rear side door of the minivan of FIG. 1;

FIG. 10 is a schematic view depicting a relationship between upper and lower pathways traveled by roller members of the sliding rear side door of the minivan of FIG. 1 as the sliding rear side door moves between closed and opened positions, and further depicting a relationship of the upper and lower pathways with a rotational axis of a rear wheel of the minivan of FIG. 1;

FIG. 11 is a perspective view depicting a left sliding rear side door and associated guide tracks removed from a conventional minivan, wherein portions of the sliding door are shown in dashed lines for clarity of illustration;

FIG. 12 is an enlarged top plan view depicting the left sliding rear side door and associated upper guide track of FIG. 11, wherein certain hidden surfaces of the upper guide track are shown in dashed lines;

FIG. 13 is an enlarged top cross-sectional view depicting the left sliding rear side door and associated lower guide track of FIG. 1, wherein certain hidden surfaces of the lower guide track are shown in dashed lines; and

FIG. 14 is an enlarged top plan view depicting portions of the upper guide track and the left sliding rear side door of FIG. 1 in association with a driver door of the conventional minivan.

### DETAILED DESCRIPTION

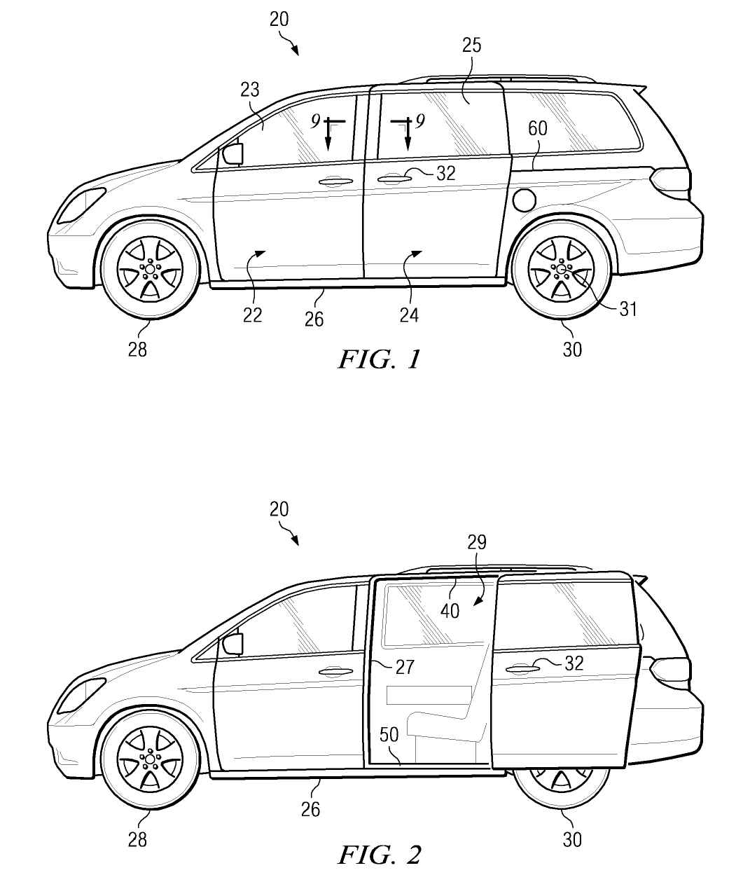

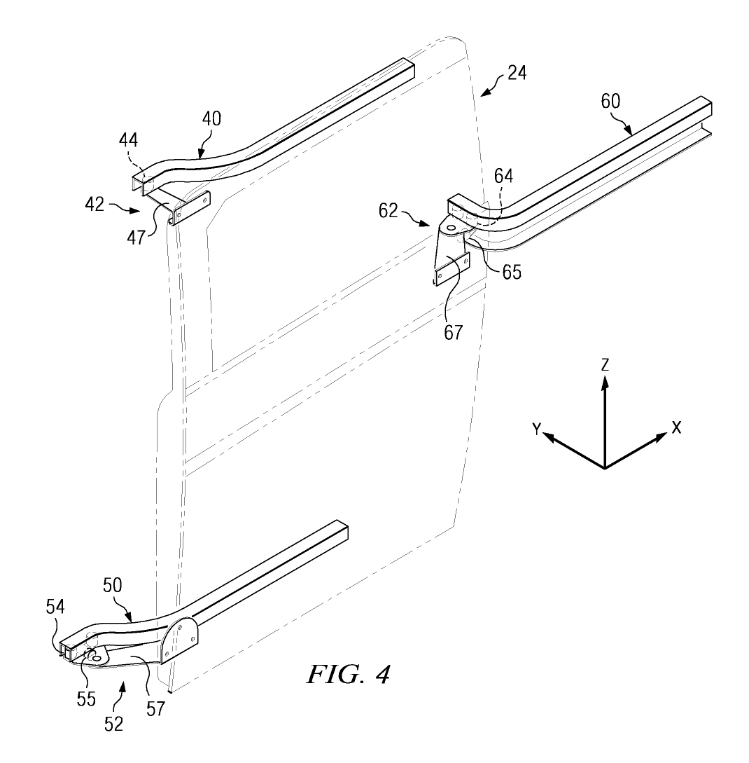

Certain embodiments are hereinafter described in detail in connection with the views and examples of FIGS. 1-10. A vehicle can be provided with a sliding mechanism which moveably supports a sliding door with respect to a body structure of the vehicle. In one embodiment, the vehicle can comprise a van, such as of a type which is often referred to as a minivan, an example of which is shown in FIGS. 1-2. However, in other embodiments, the vehicle can comprise an automobile, a truck, a bus, and/or any of a variety of other types of vans or other vehicles which include at least one sliding door.

A vehicle 20 is shown in FIGS. 1-2 to comprise a driver door 22 and a sliding door 24 which are each moveably attached to a body structure 26 of the vehicle 20. The body structure 26 can comprise frame members, body members, and/or other components that generally define the shell of the vehicle 20. In one embodiment, the body structure 26 can comprise a unibody-type structure. In other embodiments, the body structure 26 can comprise multiple body panels welded to an underlying frame structure. The body structure 26 can define a passenger compartment (shown as 29 in FIG. 2) which is configured to support and hold people and/or cargo during use of the vehicle 20.

While the driver door 22 can be hingedly attached to the body structure 26 to facilitate access to, and egress from, the passenger compartment 29 by a driver of the vehicle 20, it will be appreciated that the sliding door 24 can be slideably attached to the body structure 26 to facilitate access to, and egress from, the passenger compartment 29 by cargo and/or a passenger of the vehicle 20, as discussed in further detail below. The driver door 22 is shown to comprise a window 23, and the sliding door 24 is shown to comprise a window 25, although it will be appreciated that such doors might alternatively not include windows. It will also be appreciated that a similar arrangement of doors can be provided upon the opposite side of the vehicle 20. In another embodiment, it will be appreciated that a vehicle might alternatively include only a single sliding door oriented upon either the left side or right side of the vehicle. It will also be appreciated that a sliding door can be provided in any of a variety of suitable locations upon other types of vehicles. Also, while the driver door 22 is shown in FIG. 1 to be provided on a left side of the vehicle 20, it will be appreciated that a driver door can alternatively be provided upon a right side of a vehicle.

The vehicle 20 can comprise front wheels (e.g., 28) and rear wheels (e.g., 30) which are rotatably supported with respect to the body structure 26. The front wheels (e.g., 28) are generally steerable by a driver of the vehicle 20 to facilitate steering of the vehicle 20. At least one of the front wheels (e.g., 28) and/or the rear wheels (e.g., 30) can be coupled to a source of motive power such as, for example, an engine and/or electric motor (not shown) to facilitate propulsion of the vehicle 20. It will be appreciated that, as the vehicle 20 travels along the ground, the rear wheels (e.g., 30) can rotate about a rotational axis 31 (shown in FIG. 1) with respect to the body structure 26.

The sliding door 24 is shown to comprise a left sliding rear side door of the vehicle 20. The body structure 26 can define an access opening 27 to the passenger compartment 29, as shown in FIG. 2. The sliding door 24 can be movable with respect to the body structure 26 between closed and opened positions, as shown in FIGS. 1 and 2, respectively. When the sliding door 24 is in the closed position (shown in FIG. 1), the sliding door 24 can prevent passage of cargo and/or a passenger through the access opening 27. However, when the sliding door 24 is in an opened position, the sliding door 24 can facilitate passage of cargo and/or a passenger through the access opening 27. While the sliding door 24 is shown to be in a fully opened position in FIG. 2, it will be appreciated that the sliding door 24 can alternatively assume other opened positions (i.e., partially opened positions) which can facilitate passage of cargo and/or a passenger through the access opening 27.

The sliding door 24 is shown in FIGS. 1-2 to include an exterior handle 32 to facilitate manual sliding of the sliding door 24 between closed and opened positions by a person on the exterior of the vehicle 20. The sliding door 24 might additionally or alternatively include a similar handle (not shown) attached to an interior portion of the sliding door 24 to facilitate manual sliding of the sliding door 24 between closed and opened positions by a passenger within the passenger compartment 29 of the vehicle 20. Additionally or alternatively, a power actuator (e.g., including an electric motor and gearing) might be associated with the sliding door 24 to facilitate powered sliding of the sliding door 24 between closed and opened positions as directed by a driver or passenger of the vehicle 20.

Any of a variety of suitable sliding mechanisms can be provided to facilitate attachment of a sliding door to a body structure of a vehicle such that the sliding door is movable with respect to the body structure between closed and opened positions. Such a sliding mechanism can include at least one guide track and at least one roller member. In one embodiment, the guide track(s) can be attached to the body structure of a vehicle and the roller member(s) can be attached to the sliding door. However, in another embodiment, one or more guide tracks can be attached to a sliding door and one or more roller members can be attached to a body structure of a vehicle.

In the embodiment of FIGS. 1-10, the vehicle 20 is shown to include upper, lower, and center guide tracks 40, 50, and 60 which are attached to the body structure 26 such as with welding, fasteners, and/or adhesives. It will be appreciated that part or all of one or more of the upper, lower, and center guide tracks 40, 50, and 60 can be formed as a unitary member with one or more portions of the body structure 26. Furthermore, in the embodiment of FIGS. 1-10, the sliding door 24 is shown to comprise upper, lower, and center roller members 42, 52, and 62. The upper, lower, and center roller members 42, 52, and 62 can be attached to other portions of the sliding door 24 with fasteners, welding, and/or adhesives, for example. Though the sliding door 24 is shown to be moveably attached to the body structure 26 through use of three guide tracks (i.e., 40, 50, and 60) and three roller members (i.e., 42, 52, and 62), it will be appreciated that a sliding mechanism on an alternative vehicle might include fewer or more guide tracks and/or roller members.

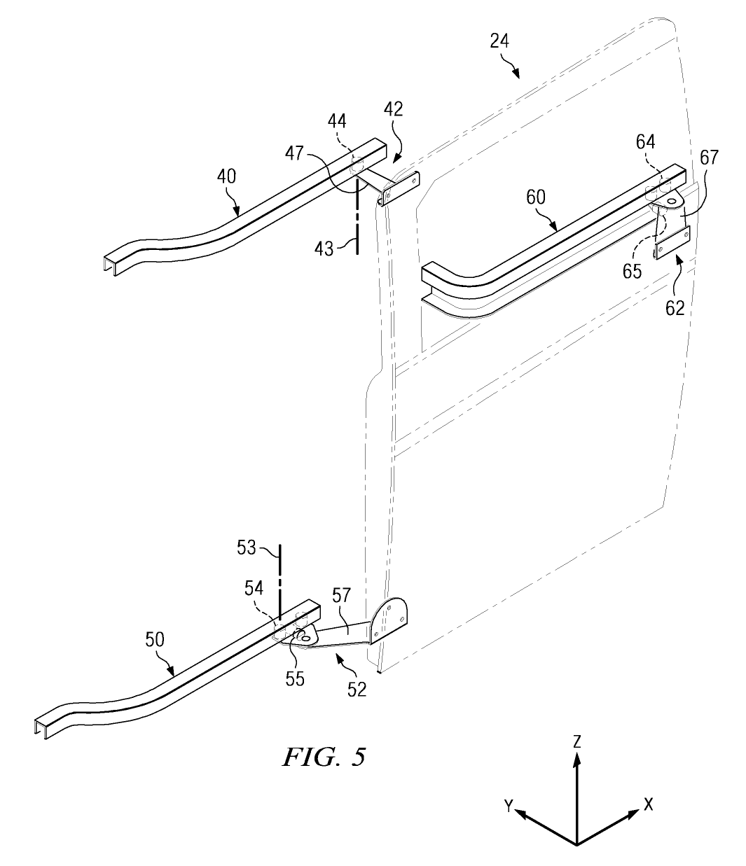

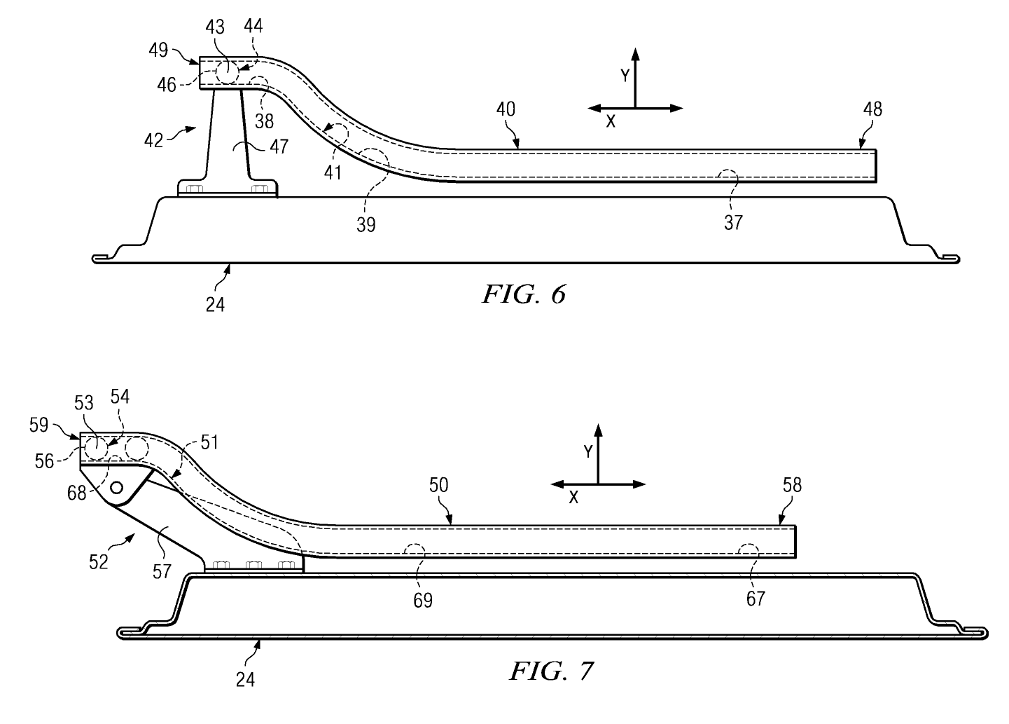

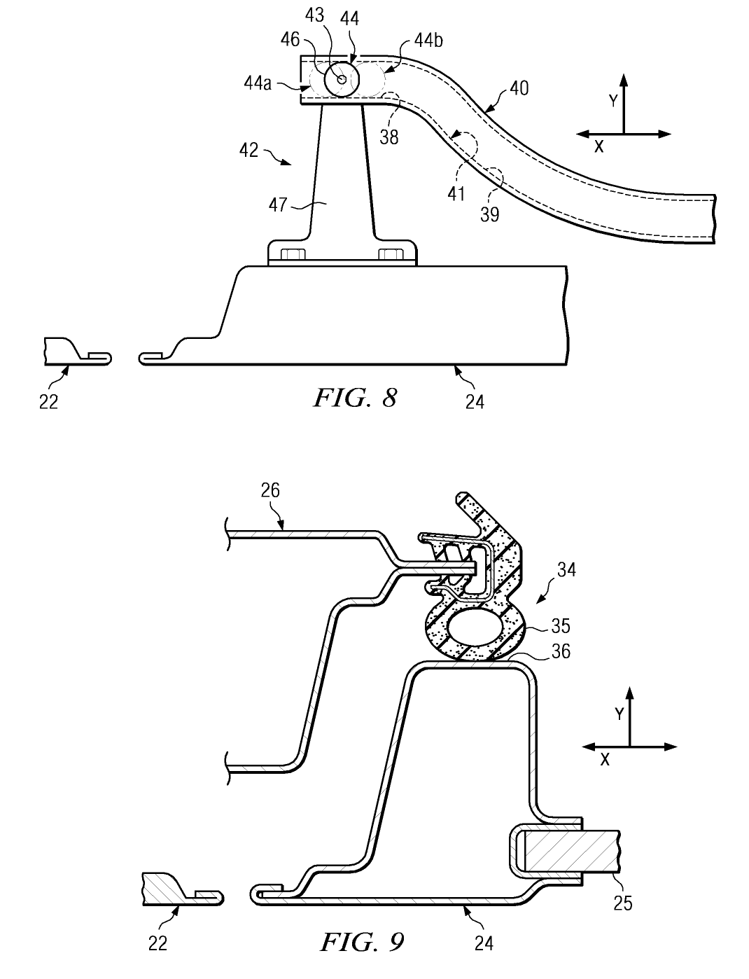

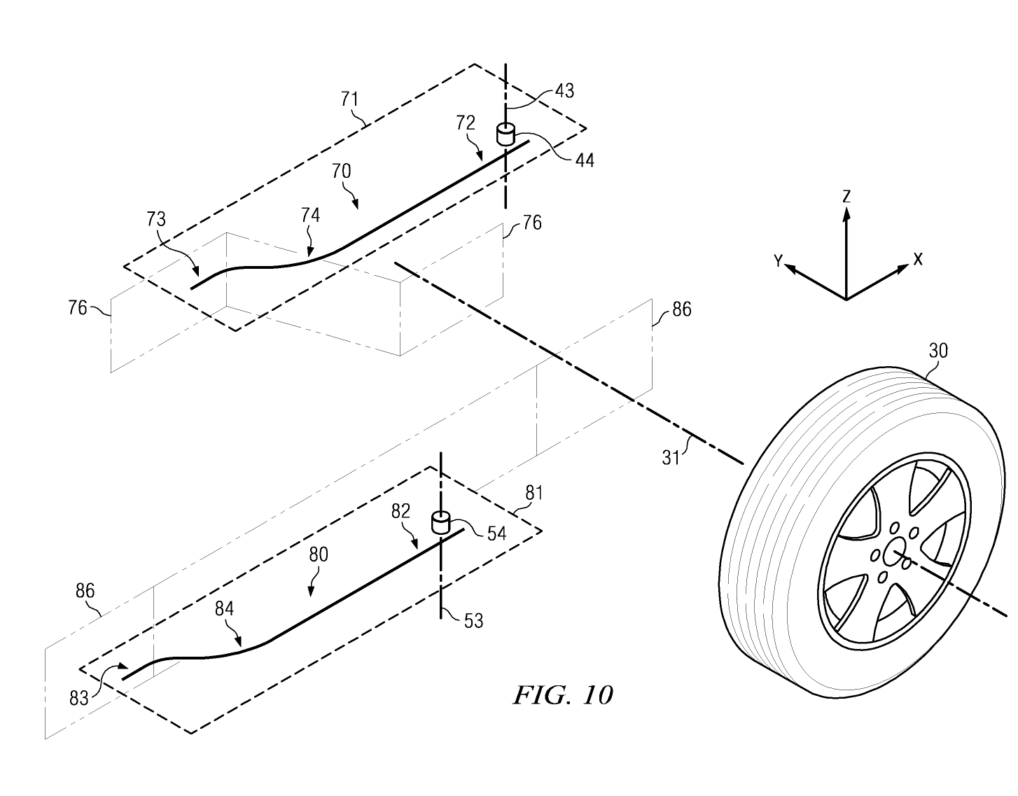

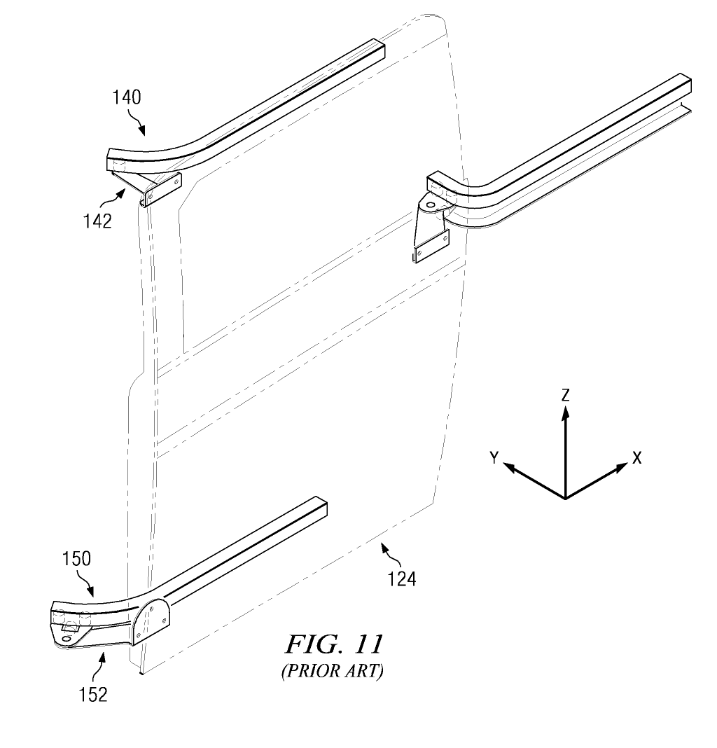

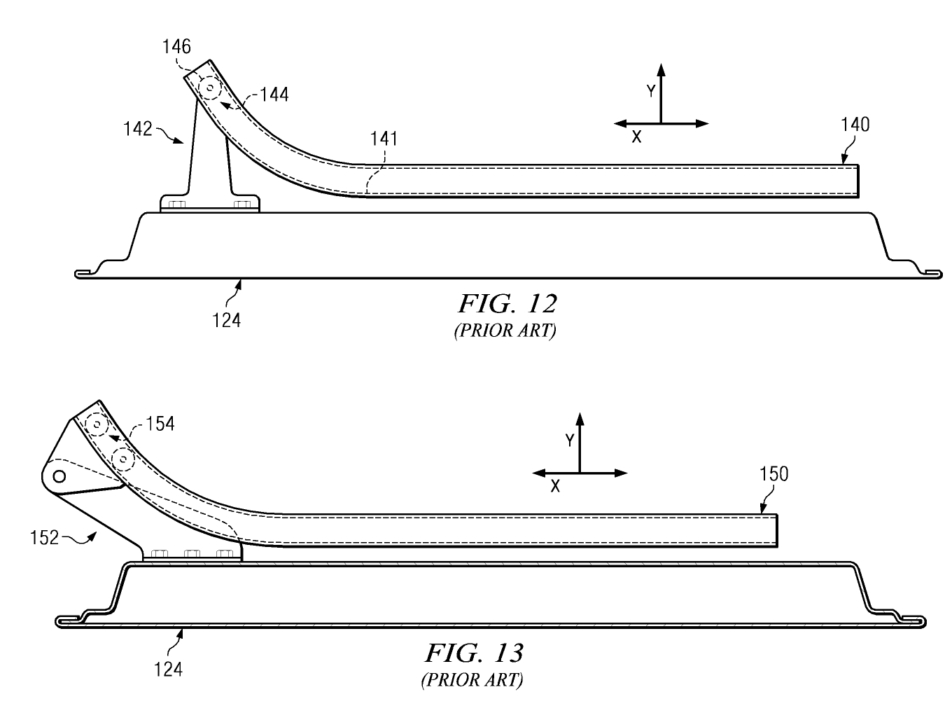

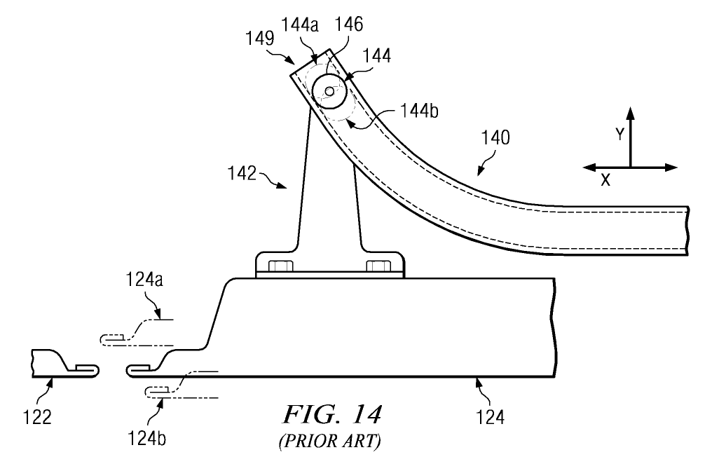

Referring to FIGS. 2-8, the upper roller member 42 can be movably engaged with the upper guide track 40 such that the upper roller member 42 is constrained by the upper guide track 40 to move along an upper pathway 70 (shown in FIG. 10) as the sliding door 24 moves between the closed (FIG. 1) and opened (FIG. 2) positions. For example, the upper roller member 42 can comprise a bracket 47 and a wheel or disk 44. The disk 44 can be attached to the bracket 47 such that the disk 44 is rotatable about an axis (e.g., axis 43 in FIGS. 5-6 and 8). The disk 44 can include a circumferential surface 46 (FIGS. 6 and 8) which can contact an engagement surface 41 (FIGS. 6 and 8) of the upper guide track 40 as the sliding door 24 moves between the closed (FIG. 1) and opened (FIG. 2) positions. In one embodiment (e.g., as in FIG. 6), to facilitate smooth sliding movement of the sliding door 24 with respect to the body structure 26, the sliding mechanism can be configured such that the circumferential surface 46 continually contacts the engagement surface 41 as the sliding door 24 moves between the closed (FIG. 1) and opened (FIG. 2) positions, and thus as the disk 44 of the upper roller member 42 moves between first and second ends 48 and 49 of the upper guide track 40 as shown in FIG. 6. It will be appreciated that an upper roller member can also include additional rotatable disks for contacting an engagement surface of an upper guide track. It will also be appreciated that an upper roller member can contact and engage an upper guide track in any of a variety of other suitable arrangements and/or configurations.

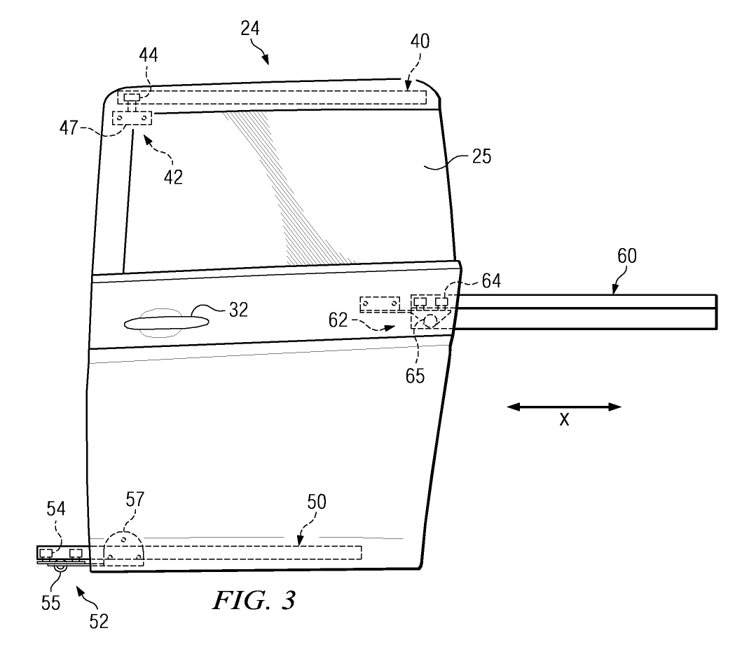

Likewise, the lower roller member 52 can be movably engaged with the lower guide track 50 such that the lower roller member 52 is constrained by the lower guide track 50 to move along a lower pathway 80 (shown in FIG. 10) as the sliding door 24 moves between the closed (FIG. 1) and opened (FIG. 2) positions. For example, the lower roller member 52 can comprise a bracket 57 and a wheel or disk 54. The disk 54 can be attached to the bracket 57 such that the disk 54 is rotatable about an axis (e.g., axis 53 in FIGS. 5 and 7). The disk 54 can include a circumferential surface 56 (FIG. 7) which can contact an engagement surface 51 (FIG. 7) of the lower guide track 50 as the sliding door 24 moves between the closed (FIG. 1) and opened (FIG. 2) positions. In one embodiment (e.g., as in FIG. 7), to facilitate smooth sliding movement of the sliding door 24 with respect to the body structure 26, the sliding mechanism can be configured such that the circumferential surface 56 continually contacts the engagement surface 51 as the sliding door 24 moves between the closed (FIG. 1) and opened (FIG. 2) positions, and thus as the disk 54 of the lower roller member 52 moves between first and second ends 58 and 59 of the lower guide track 50 as shown in FIG. 7. It will be appreciated that the lower roller member 52 can also include additional rotatable disks which are attached to the bracket 57 and which are configured for contacting an engagement surface of the lower guide track 50. For example, as shown in FIG. 3, the lower roller member 52 can comprise another wheel or disk 55 which is attached to the bracket 57 for rotation about an axis (e.g., perpendicular to the axis 53). The disk 55 can include a circumferential surface which can contact another engagement surface (e.g., an edge of a downwardly-directed side wall of a C-channel) provided by the lower guide track 50 as the sliding door 24 moves between the closed (FIG. 1) and opened (FIG. 2) positions. It will be appreciated that a lower roller member can contact and engage a lower guide track in any of a variety of other suitable arrangements and/or configurations.

The center roller member 62 can also be movably engaged with the center guide track 60 as the sliding door 24 moves between the closed (FIG. 1) and opened (FIG. 2) positions. For example, the center roller member 62 can comprise a bracket 67 and one or more wheels or disks (e.g., 64, 65 in FIGS. 3-5) which are rotatably attached to the bracket 67 and each include a circumferential surface which can contact one or more engagement surfaces provided by the center guide track 60 as the sliding door 24 moves between the closed (FIG. 1) and opened (FIG. 2) positions. In one embodiment, to facilitate smooth sliding movement of the sliding door 24 with respect to the body structure 26, the sliding mechanism can be configured such that this contact can be continuous as the sliding door 24 moves between the closed (FIG. 1) and opened (FIG. 2) positions. It will be appreciated that a center roller member can contact and engage a center guide track in any of a variety of other suitable arrangements and/or configurations.

In one embodiment, with reference to FIGS. 6 and 10, the upper engagement surface 41 of the upper guide track 40 can define the upper pathway 70 as the disk 44 rolls along in contact with the upper engagement surface 41 as the sliding door 24 moves between closed (FIG. 1) and opened positions (FIG. 2). Likewise, with reference to FIGS. 7 and 10, the lower engagement surface 51 of the lower guide track 50 can define the lower pathway 80 as the disk 54 rolls along in contact with the lower engagement surface 51 as the sliding door 24 moves between closed (FIG. 1) and opened positions (FIG. 2). It will be appreciated that one or more different portions of a guide track can define a pathway for movement of a roller member depending, of course, upon the configuration and arrangement of the engagement between the roller member and the guide track.

The upper engagement surface 41 is shown in FIG. 6 to comprise a first linear section 37, a second linear section 38, and a curvilinear section 39 separating the first and second linear sections 37 and 38. With reference to FIGS. 6 and 10, it will be appreciated that the first linear section 37 of the upper engagement surface 41 can define a first linear portion 72 of the upper pathway 70; the second linear section 38 of the upper engagement surface 41 can define a second linear portion 73 of the upper pathway 70; and the curvilinear section 39 of the upper engagement surface 41 can define a curvilinear portion 73 of the upper pathway 70. Likewise, as shown in FIG. 7, the lower engagement surface 51 can comprise a first linear section 67, a second linear section 68, and a curvilinear section 69 separating the first and second linear sections 67 and 68. With reference to FIGS. 7 and 10, it will be appreciated that the first linear section 67 of the lower engagement surface 51 can define a first linear portion 82 of the lower pathway 80; the second linear section 68 of the lower engagement surface 51 can define a second linear portion 83 of the lower pathway 80; and the curvilinear section 69 of the lower engagement surface 51 can define a curvilinear portion 83 of the lower pathway 80.

The curvilinear portion 74 of the upper pathway 70 can separate the first and second linear portions 72 and 73 of the upper pathway 70, as shown in FIG. 10. The first and second linear sections 37 and 38 can be parallel with one another such that the first and second linear portions 72 and 73 are parallel with one another, as shown in FIG. 10. The entirety of the upper pathway 70 is shown in FIG. 10 to lie within a plane 71. In one embodiment, with reference to FIGS. 5 and 10, the axis 43 of rotation of the disk 44 can be perpendicular to the plane 71. However, it will be appreciated that, in other embodiments, any disk of a roller member contacting a guide track might not rotate about an axis perpendicular to a plane defined by the pathway of the roller member traveled with respect to the guide track.

The upper guide track 40 is shown in FIG. 6 to extend between the first and second ends 48 and 49. With reference to FIGS. 6 and 10, the first linear section 37 of the engagement surface 41, and thus the first linear portion 72 of the upper pathway 70, can be at the first end 48 of the upper guide track 40. The second linear section 38 of the engagement surface 41, and thus the second linear portion 73 of the upper pathway 70, can be at the second end 49 of the upper guide track 40. When the sliding door 24 is in the opened position (see FIGS. 2 and 5), the circumferential surface 46 of the disk 44 can contact the first linear section 37 of the engagement surface 41 such that the upper roller member 42 can be positioned at the first linear portion 72 of the upper pathway 70. When the sliding door 24 is in the closed position (see FIGS. 1, 2-4 and 6), the circumferential surface 46 of the disk 44 can contact the second linear section 38 of the engagement surface 41 such that the upper roller member 42 can be positioned at the second linear portion 73 of the upper pathway 70. With reference to FIG. 10, the second linear portion 73 can lie within a plane 76 which perpendicularly intersects the rotational axis 31 of the rear wheel(s) (e.g., 30) of the vehicle 20. It will be appreciated that the second linear section 38 of the engagement surface 41 can also lie within the plane 76. In one embodiment, the plane 76 can also perpendicularly intersect the plane 71.

Similarly, the curvilinear portion 84 of the lower pathway 80 can separate the first and second linear portions 82 and 83 of the lower pathway 80, as shown in FIG. 10. The first and second linear sections 67 and 68 can be parallel with one another such that the first and second linear portions 82 and 83 are parallel with one another, as shown in FIG. 10. The entirety of the lower pathway 80 is shown in FIG. 10 to lie within a plane 81. In one embodiment, with reference to FIGS. 5 and 10, the axis 53 of rotation of the disk 54 can be perpendicular to the plane 81. However, it will be appreciated that, in other embodiments, any disk of a roller member contacting a guide track might not rotate about an axis perpendicular to a plane defined by the pathway of the roller member traveled with respect to the guide track.

The lower guide track 50 is shown in FIG. 7 to extend between the first and second ends 58 and 59. With reference to FIGS. 7 and 10, the first linear section 67 of the engagement surface 51, and thus the first linear portion 82 of the lower pathway 80, can be at the first end 58 of the lower guide track 50. The second linear section 68 of the engagement surface 51, and thus and the second linear portion 83 of the lower pathway 80, can be at the second end 59 of the lower guide track 50. When the sliding door 24 is in the opened position (see FIGS. 2 and 5), the circumferential surface 56 of the disk 54 can contact the first linear section 67 of the engagement surface 51 such that the lower roller member 52 can be positioned at the first linear portion 82 of the lower pathway 80. When the sliding door 24 is in the closed position (see FIGS. 1, 2-4 and 6), the circumferential surface 56 of the disk 54 can contact the second linear section 68 of the engagement surface 51 such that the lower roller member 52 can be positioned at the second linear portion 83 of the lower pathway 80. With reference to FIG. 10, the second linear portion 83 can lie within a plane 86 which perpendicularly intersects the rotational axis 31 of the rear wheel(s) (e.g., 30) of the vehicle 20. It will be appreciated that the second linear section 68 of the engagement surface 51 can also lie within the plane 86. In one embodiment, the plane 86 can also perpendicularly intersect the plane 81. In another embodiment, the plane 71 can be parallel with the plane 81 and/or the plane 76 can be parallel with the plane 86. In yet another embodiment, each of the planes 71 and 81 can be perpendicular to each of the planes 76 and 86.

With reference to the X-axis, the Y-axis, and the Z-axis shown in FIGS. 3-10, it will be appreciated that the X-axis can be directed generally fore-aft along the vehicle 20, the Y-axis can be directed generally laterally or side-to-side along the vehicle 20, and the Z-axis can be directed generally up-down or vertically along the vehicle 20. As the sliding door 24 moves (i.e., along the X-axis) from a nearly closed position to the closed position (the closed position shown in FIGS. 1, 3-4 and 6-9), and as the upper and lower roller members 42 and 52 accordingly approach the respective second ends 49 and 59 of the upper and lower guide tracks 40 and 50, the upper and lower roller members 42 and 52 move (also along the X-axis) along the respective second linear portions 73 and 83 of the upper and lower pathways 70 and 80. When the sliding door 24 is in the closed position, a seal surface 35 of a seal member 34 attached to the body structure 26 can contact a surface 36 of the sliding door 24 to provide a barrier to passage of moisture and air through the access opening 27, as shown in FIG. 9.

Slight variation in position of the sliding door 24, when in the closed position, can result in slight movement (along the X-axis) of the upper and lower roller members 42 and 52 relative to the respective upper and lower guide tracks 40 and 50. FIG. 8 illustrates alternative positions 44a and 44b which can be assumed by the disk 44 of the upper roller member 42 such as if the sliding door 24 moves slightly when in the closed position. It will be appreciated that the disks (e.g., 54) of the lower roller member 52 can behave similarly in such circumstances. However, the upper and lower roller members 42 and 52 can, despite such slight movement of the sliding door 24 when in the closed position, remain at the respective second linear portions 73 and 83 of the respective upper and lower pathways 70, 80. As such, the slight movement of the sliding door 24 results in movement of the upper and lower roller members 42 and 52, and accordingly the surface 36 of the sliding door 24, along a straight line with respect to the seal member 34 (i.e., along the X-axis, and without any movement along the Y-axis). It will be appreciated that, in the embodiment of FIG. 9, such straight-line movement would not result in any variation in the amount of compression experienced by the seal member 34 resulting from contact of the seal surface 35 with the surface 36 of the sliding door 24.

Accordingly, despite slight variations in position of the sliding door 24 when in the closed position, a constant distance can be maintained (i.e., measured along the Y-axis) for sealing by the seal member 34 between the body structure 26 and the surface 36 of the sliding door 24. The seal member 34 can accordingly maintain an effective seal despite slight variations in the position of the sliding door 24 when in the closed position. In addition, it will be appreciated that this configuration facilitates a consistent fit and finish of the outer body panel of the sliding door 24 with respect to adjacent body panels (e.g., provided by the driver door 22) of the vehicle 20, and that this configuration can accordingly contribute to efficient manufacturing of the vehicle 20. Furthermore, in this configuration, it will be appreciated that the useful life of the seal member 34 can be maximized, and that the seal member 34 can be unlikely to produce a squeaking noise when the sliding door 24 experiences slight variations in position when closed. Additionally, through use of this configuration, large amounts of force might not be required of a person or power actuator to move the sliding door 24 to or from its closed position.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A vehicle comprising:
a body structure;
a guide track attached to the body structure and comprising an engagement surface, the engagement surface having a first linear section, a second linear section, and a curvilinear section separating the first and second linear sections, wherein the first and second linear sections are parallel with one another; and
a sliding door comprising a roller member, the roller member comprising a disk having a circumferential surface, wherein the circumferential surface contacts the engagement surface as the sliding door moves with respect to the body structure between closed and opened positions; wherein:
the circumferential surface of the disk contacts the first linear section of the engagement surface when the sliding door is in the opened position; and
the circumferential surface of the disk contacts the second linear section of the engagement surface when the sliding door is in the closed position.

2. The vehicle of claim 1 wherein the circumferential surface continually contacts the engagement surface as the sliding door moves between the closed and opened positions.

3. The vehicle of claim 1 further comprising at least one front wheel and at least one rear wheel, wherein the rear wheel is rotatable with respect to the body structure about a rotational axis, and wherein the second linear section of the engagement surface lies within a plane which perpendicularly intersects the rotational axis.

4. The vehicle of claim 1 being a minivan, wherein the sliding door comprises a sliding rear side door of the minivan, the body structure defines an access opening to a passenger compartment, the sliding door in the closed position is configured to prevent passage of a passenger through the access opening, and the sliding door in the opened position is configured to facilitate passage of a passenger through the access opening.

5. A vehicle comprising:
a body structure;
a guide track attached to the body structure; and
a sliding door comprising a roller member and movable with respect to the body structure between closed and opened positions, wherein the roller member is movably engaged with the guide track and is constrained by the guide track to move along a pathway as the sliding door moves between the closed and opened positions, the pathway comprises a first linear portion, a second linear portion, and a curvilinear portion separating the first and second linear portions, the roller member is positioned at the first linear portion of the pathway when the sliding door is in the opened position, the roller member is positioned at the second linear portion of the pathway when the sliding door is in the closed position, and the first and second linear portions are parallel with one another.

6. The vehicle of claim 5 wherein the roller member comprises a disk, the entirety of the pathway lies within a plane, and the disk is rotatable about an axis perpendicular to the plane.

7. The vehicle of claim 5 wherein the roller member comprises a disk, the disk comprises a circumferential surface, the guide track comprises an engagement surface, the engagement surface defines the pathway, and the circumferential surface contacts the engagement surface.

8. The vehicle of claim 7 wherein the circumferential surface continually contacts the engagement surface as the sliding door moves between the closed and opened positions.

9. The vehicle of claim 5 further comprising at least one front wheel and at least one rear wheel, wherein the rear wheel is rotatable with respect to the body structure about a rotational axis, and wherein the second linear portion lies within a plane which perpendicularly intersects the rotational axis.

10. The vehicle of claim 5 being a minivan, wherein the sliding door comprises a sliding rear side door of the minivan, the body structure defines an access opening to a passenger compartment, the sliding door in the closed position is configured to prevent passage of a passenger through the access opening, and the sliding door in the opened position is configured to facilitate passage of a passenger through the access opening.

11. A vehicle comprising:
a body structure;
at least one front wheel;
at least one rear wheel rotatable with respect to the body structure about a rotational axis;
a guide track attached to the body structure; and
a sliding door comprising a roller member and movable with respect to the body structure between closed and opened positions, wherein the roller member is movably engaged with the guide track and is constrained by the guide track to move along a pathway as the sliding door moves between the closed and opened positions, the pathway comprises a first linear portion, a second linear portion, and a curvilinear portion separating the first and second linear portions, the roller member is positioned at the first linear portion of the pathway when the sliding door is in the opened position, the roller member is positioned at the second linear portion of the pathway when the sliding door is in the closed position, and the second linear portion lies within a plane which perpendicularly intersects the rotational axis of said rear wheel.

12. The vehicle of claim 11 wherein the roller member comprises a disk, the entirety of the pathway lies within a plane, and the disk is rotatable about an axis perpendicular to the plane.

13. The vehicle of claim 11 wherein the roller member comprises a disk, the disk comprises a circumferential surface, the guide track comprises an engagement surface, the engagement surface defines the pathway, and the circumferential surface continually contacts the engagement surface as the sliding door moves between the closed and opened positions.

14. The vehicle of claim 11 being a minivan, wherein the sliding door comprises a sliding rear side door of the minivan, the body structure defines an access opening to a passenger compartment, the sliding door in the closed position is configured to prevent passage of a passenger through the access opening, and the sliding door in the opened position is configured to facilitate passage of a passenger through the access opening.

15. A sliding mechanism configured for attaching a sliding door to a body structure of a vehicle such that the sliding door is movable with respect to the body structure between closed and opened positions, the sliding mechanism comprising:
a guide track configured for attachment to a body structure of a vehicle and extending between first and second ends; and
a roller member configured for attachment to a sliding door, wherein the roller member is movably engaged with the guide track and is constrained by the guide track to move along a pathway, the pathway comprises a first linear portion, a second linear portion, and a curvilinear portion separating the first and second linear portions, the first linear portion of the pathway is at the first end of the guide track, and the first and second linear portions are parallel with one another.

16. The sliding mechanism of claim 15 wherein the roller member comprises a disk, the entirety of the pathway lies within a plane, and the disk is rotatable about an axis perpendicular to the plane.

17. The sliding mechanism of claim 15 wherein the roller member comprises a disk, the disk comprises a circumferential surface, the guide track comprises an engagement surface, the engagement surface defines the pathway, and the circumferential surface contacts the engagement surface.

18. The sliding mechanism of claim 17 wherein the circumferential surface continually contacts the engagement surface as the roller member moves between the first and second ends of the guide track.

19. The sliding mechanism of claim 15 wherein the second linear portion of the pathway is at the second end of the guide track.
